(19) United States
(12) Patent Application Publication
(10) Pub. No.: US 2024/0368942 A1
(43) Pub. Date: Nov. 7, 2024

(54) Pet ladder that adjust the angle of the ramp

(71) Applicant: SHENZHEN HUIKAIDA TECHNOLOGY CO., LTD, Shenzhen (CN)

(72) Inventor: He ZHANG, Guangzhou (CN)

(21) Appl. No.: 18/772,395

(22) Filed: Jul. 15, 2024

(30) Foreign Application Priority Data
Jun. 12, 2024 (CN) 202421334200.6

(51) Int. Cl. E06C 7/08; A01K 1/035; E06C 1/383; E06C 7/46

(52) U.S. Cl. CPC E06C 7/08; A01K 1/035; E06C 1/383; E06C 7/46

(57) ABSTRACT

The present invention provides a pet ladder that adjusts the angle of the ramp, including: the first ladder body and two second ladder bodies, the first ladder body and the two second ladder bodies are fixed internally, the two rotating members are connected to the side of the first ladder body and the second ladder body, the second ladder body opposite the first ladder body, the protective assembly is provided at one end of the second ladder body, the rotating assembly is provided at one end of the second ladder body, and the adjusting erection is placed on the side of the rotary assembly. According to the present invention, a pet ladder operates between the rotating parts, the rotating component, the rotating assembly and the rotating component with the adjustment frame between the first ladder body and the second ladder body, with excellent comfort.

### TECHNICAL FIELD

The invention relates to the field of pet ladder, in particular to a pet ladder that adjust the angle of the ramp.

### BACKGROUND TECHNOLOGY

Pet ladder is an aid designed for pets and is usually used to help pets up and down.

At present, the pet training ground or other pet places will facilitate the training and climbing through the pet ladder.

Now the pet ladder to use the convenience of the pet ladder set into folding way, facilitate personnel to take, but fold the pet ramp in the process of use, after erection, ramp main body is not smooth, relatively sliding defects, user experience is low, and function of single cannot cope with complex environment.

Therefore, it is necessary to provide a pet ladder that adjusts the angle of the ramp to solve the technical problems mentioned above.

### INVENTION CONTENT

The present invention provides a pet ladder that can be folded to adjust the Angle of the ramp, which solves the problem that the erection of the main body of the ramp is unstable, the relative sliding of the user has a low use experience, and the single function cannot cope with the impact of complex environment.

To solve the above technical problems, the present invention provides a pet ladder with folding adjusting the ramp angle, comprising:
The first ladder body and two second ladder bodies, the first ladder body and the two second ladder bodies are provided with fixed plates;
Turning members, the number of turning members is two, two connected to the opposite side of the first ladder body and one of the second ladder body;
A rotary assembly, disposed on the side of the second ladder body opposite to the first ladder body;
Anti-skid assembly, the protective assembly is provided at one end of the second ladder body;
Rorotary assembly, the rotary assembly is disposed at one end of one of the second ladder body;
Regulating frame, the regulating erection is placed on the side of the rotating assembly.

Preferably, the rotation assembly includes two rotating blocks provided between the rotating bar.

Preferably, the rotary assembly includes a mounting frame with gear blocks on the left and right, a finite block between the two gear blocks and a spring on one side of the limit block.

Preferably, the sleeve lies between the two gear blocks with one end of the second ladder body.

Preferably, the protective assembly includes a rotating member and a side of the rotating member is connected to the second ladder body.

Preferably, the support plate is provided between the first ladder body and the second ladder body and the support plate.

Preferably, the first ladder body and the left and right sides of the second ladder body surface are provided with the protective assembly comprising a plurality of guard rails, the bottom end of the guard rail is connected with an outer threaded connecting block, and the surface thread of the outer threaded connecting block is connected with a thread sleeve.

Preferably, a connecting rope is provided between the plurality of said guard barriers.

Preferably, a finite assembly is provided between the first ladder body and the fixing plate, the limit assembly comprises four positioning seats, four positioning seats, two of the two positioning seats are connected between the circular bars, the surface sleeve of the circular bar is provided with a fixing sleeve, one side of the fixing sleeve is connected with an L-shaped connecting rod, and one end of the L-shaped connecting rod is connected to a finite plate.

Preferably, one side of the positioning seat is connected with a rectangular block provided with bolts between the rectangular block and the first ladder body.

Compared with the related techniques, a folding adjustable ramp angle pet ladder provided by the present invention has the following beneficial effects:
The present invention provides a pet ladder, between the rotating parts, the skid component, the rotating component and the rotating component with the adjustment frame, and between the small and light pet ramp, the folding pet ramp with excellent comfort and environmental protection.

### ATTACHED FIGURE DESCRIPTION

FIG. 1 is a schematic diagram of a first embodiment of a pet ladder that foland adjusts the ramp angle;

FIG. 2 shows the enlarged diagram of part A shown in FIG. 1;

FIG. 3 shows the enlarged diagram of section B shown in FIG. 1;

FIG. 4 shows the enlarged diagram of section C shown in FIG. 1;

FIG. 5 shows the enlarged D shown in FIG. 1;

FIG. 6 is a diagram of the first stereoscopic structure of the device shown in FIG. 1;

FIG. 7 shows the enlarged diagram of part E shown in FIG. 6;

FIG. 8 is a diagram of the second stereoscopic structure of the device shown in FIG. 1;

FIG. 9 shows the enlarged diagram of section F shown in FIG. 8;

FIG. 10 is a diagram of the stereoscopic structure of the apparatus shown in FIG. 1;

FIG. 11 is a diagram of the first stereoscopic structure of the apparatus shown in FIG. 1;

FIG. 12 shows the G-section enlargement diagram shown in FIG. 11;

FIG. 13 is a diagram of the second stereoscopic structure of the apparatus shown in FIG. 1;

FIG. 14 is a schematic diagram of a second embodiment of a pet ladder that foland adjusts the ramp angle;

FIG. 15 is a schematic diagram of a third embodiment of a pet ladder that foland adjusts the ramp angle;

FIG. 16 is the enlarged view of section H shown in FIG. 15;.

Figure reference number: 1, the first ladder body, 2, the second ladder body, 3, fixed plate, 4, support plate, 5, rotating parts,
6, rotating assembly, 61, rotating block, 62, rotating rod,
7, rotating assembly, 71, installation frame, 72, gear block, 73, limit block, 74, spring,
8, protective case, 9, installation parts, 10, adjustment frame,
11, protective components, 111, anti-skid seat, 112, rotating parts,
12, protective components, 121, protective guardrail, 122, external thread connection block, 123, thread sleeve, 124, connection rope,
13, limit assembly, 131, positioning seat, 132, circular rod, 133, fixed sleeve, 134, L-shaped connecting rod, 135, limit plate, 136, rectangular block, 137, bolt.

### SPECIFIC IMPLEMENTATION METHODS

The present invention is further explained below in combination with the accompanying drawings and the embodiments.

### FIRST EMBODIMENT

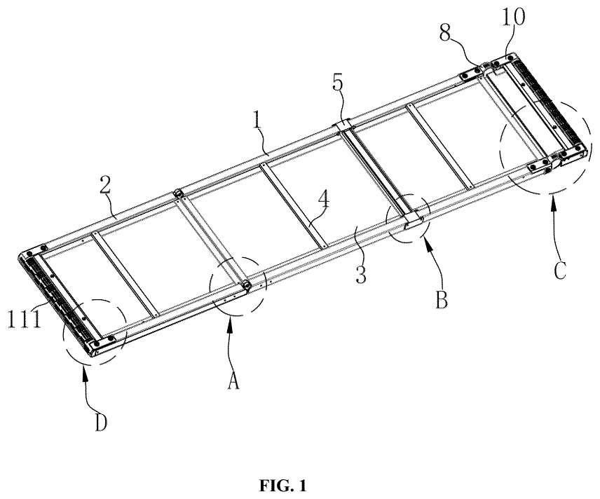

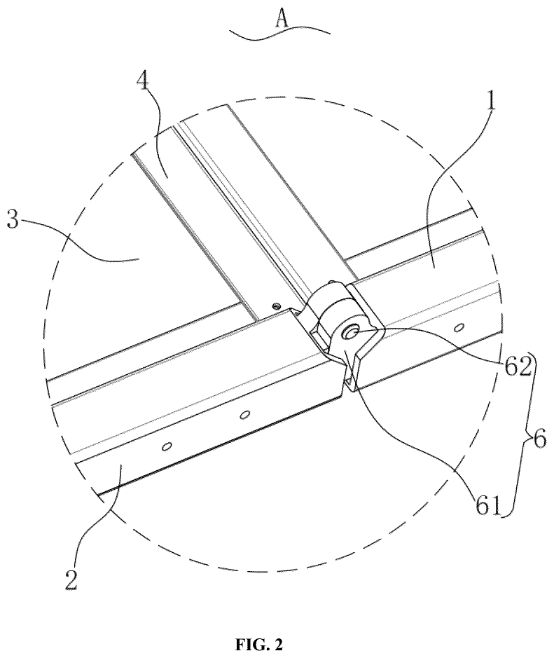

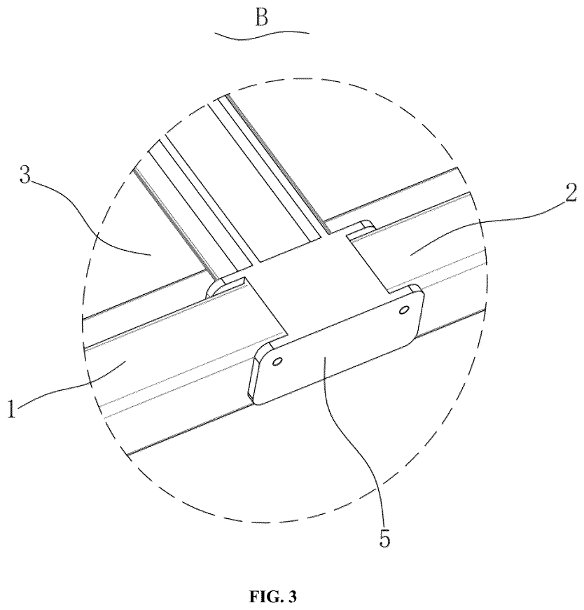

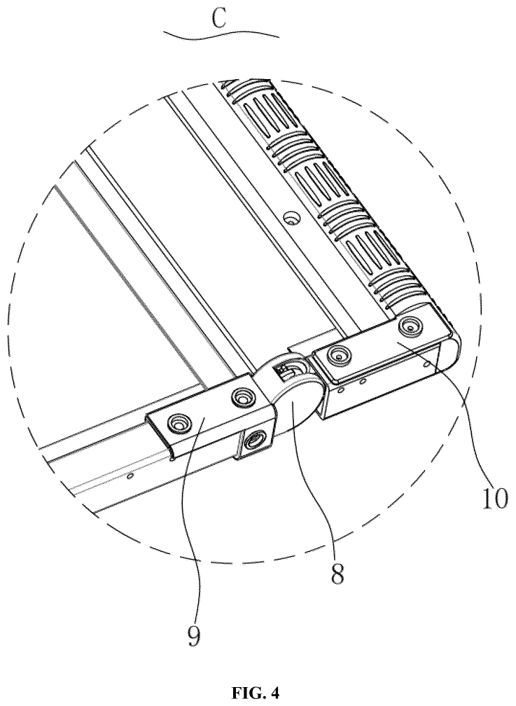

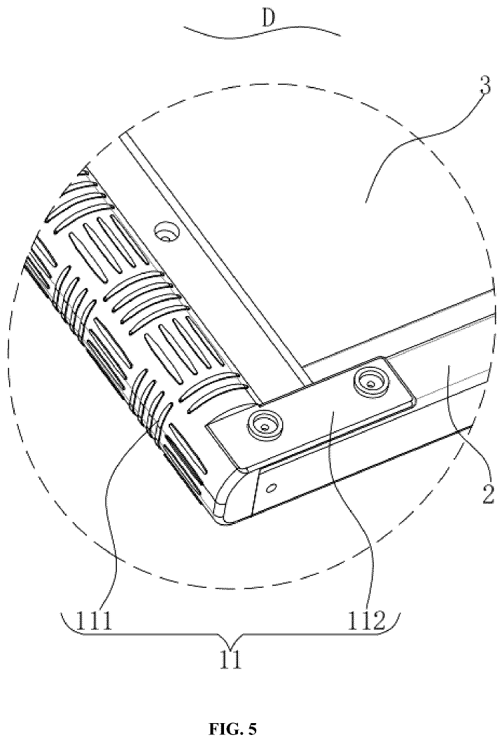

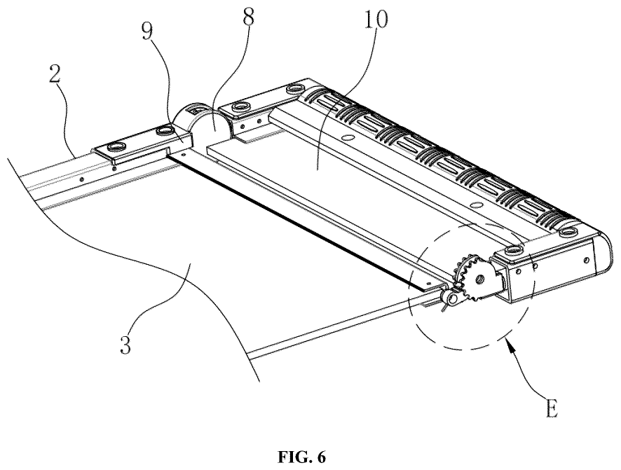

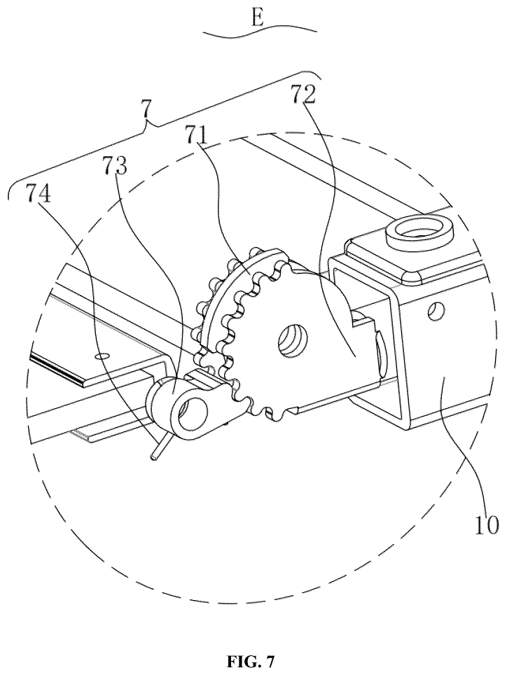

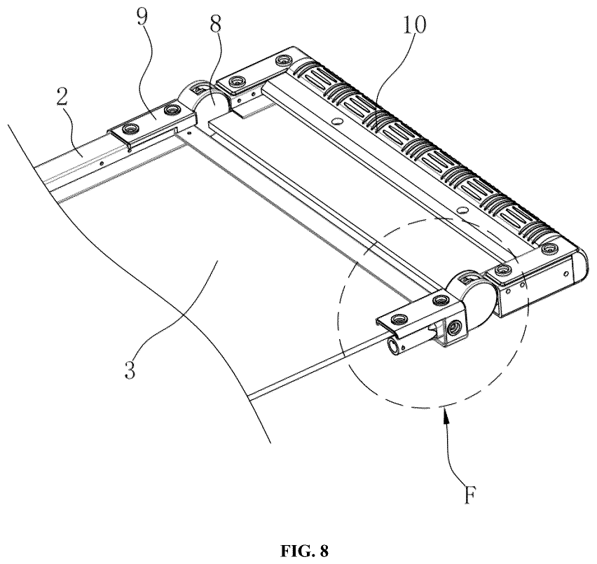

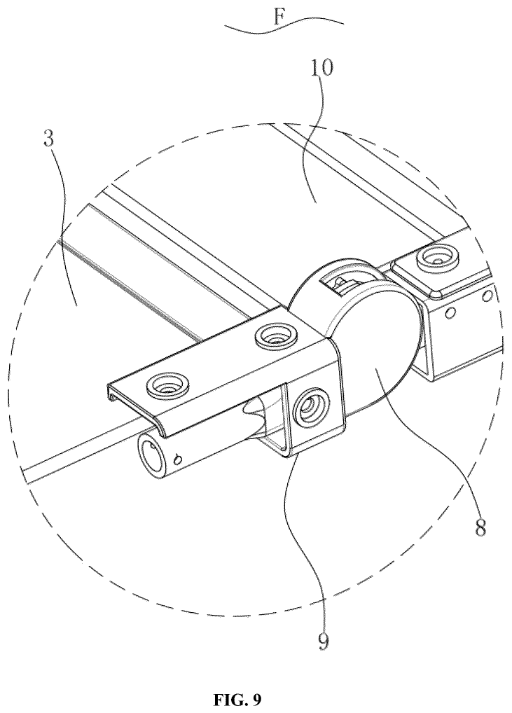

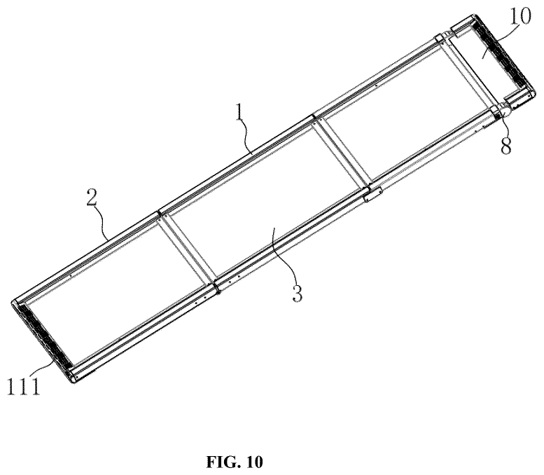

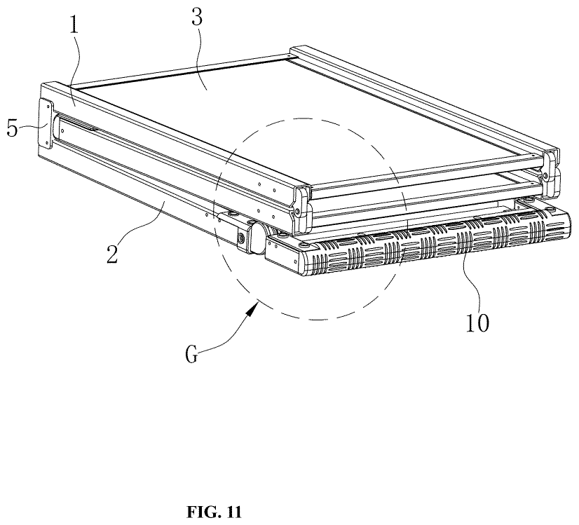

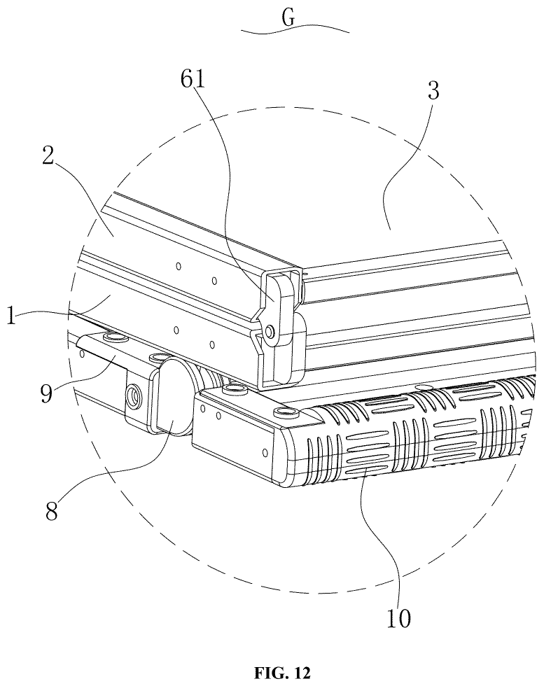

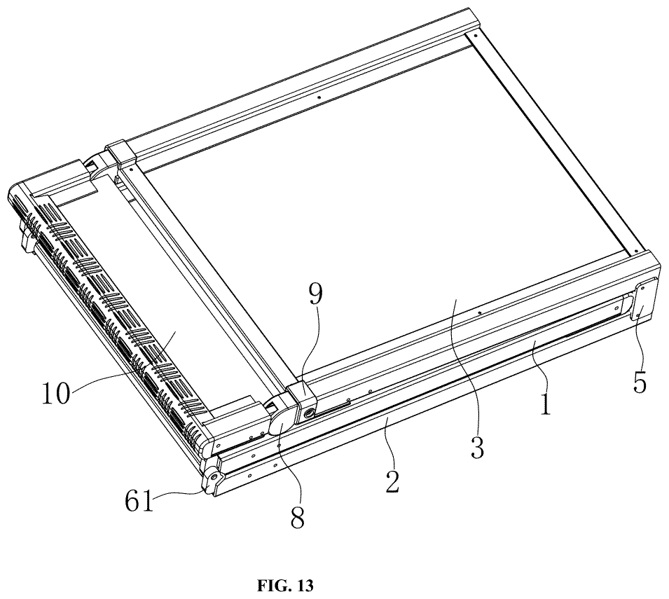

Please refer to FIGS. 1,2,3,4,5,6,7,8,9,10,11,1,12, and 13, among, FIG. 1 is a schematic diagram of a first embodiment of a pet ladder that foland adjusts the ramp angle; FIG. 2 shows the enlarged diagram of part A shown in FIG. 1; FIG. 3 shows the enlarged diagram of section B shown in FIG. 1; FIG. 4 shows the section C shown in FIG. 1; FIG. 5 shows the enlarged D shown in FIG. 1; FIG. 6 is a diagram of the first stereoscopic structure of the device shown in FIG. 1; FIG. 7 shows the enlarged diagram of part E shown in FIG. 6; FIG. 8 is a diagram of the second stereoscopic structure of the device shown in FIG. 1; FIG. 9 shows the enlarged diagram of section F shown in FIG. 8; FIG. 10 is a diagram of the stereoscopic structure of the apparatus shown in FIG. 1; FIG. 11 is a diagram of the first stereoscopic structure of the apparatus shown in FIG. 1; FIG. 12 is shown in FIG. 11; FIG. 13 is a schematic diagram of the second stereoscopic structure of the apparatus shown in FIG. 1.

A pet ladder that adjusts the angle of the ramp, including:

The first ladder body 1 and the two second ladder bodies 2, the first ladder body 1 and the two second ladder bodies 2 are provided with a fixed plate 3;

Turning member 5, the number of the turning members 5 is two, the two turning members 5 are respectively connected to the opposite side of the first ladder body 1 and one of the second ladder body 2;

A rotation assembly 6 which is provided on another side opposite the second ladder body 2 opposite the first ladder body 1;

The skid assembly 11 is provided at one end of the second ladder body 2;

A rotary assembly 7, which is disposed at one end of one of the second ladder body 2;

The adjusting frame 10, which is disposed on one side of the rotary assembly 7.

The rotation assembly 6 includes two rotating blocks 61 having a rotating bar 62 provided.

The two rotating blocks 61 are connected to the side of the first ladder body 1 and one of the second ladder body 2. In use, when folding between the first ladder body 1, the second ladder body 2 and the second ladder body 2 turns the second ladder body 2 and folds the second ladder body 2 to the surface of the first ladder body 1, fold the surface of the second ladder body 2, rotate the other second ladder body 2 through the two rotating blocks 61 and the second ladder body 2.

The rotary assembly 7 includes a mounting frame 71 provided on the left and right side of a gear block 72, a finite block 73 between the two gear blocks 72 and a spring 74 on one side of the limit block 73.

The mounting frame 71 and the two gear blocks 72 are provided with a protective sleeve 8 and one end of the second ladder body 2.

The protective assembly 11 includes a skid seat 111 with a side of the rotating member 112 connected to the second ladder body 2.

A support plate 4 is provided between the first ladder body 1 and the second ladder body 2 and the fixing plate 3.

The stress skeleton of the pet ramp is composed of aluminum alloy pipe after riveting, the main body of the ladder is toughness light plate, the link between the ladder body is linked by stainless steel hinge, the adjustable ramp plate is controlled by the adjustable angle hinge (built-in gear), the 0-90 Angle at the front end of the pet ramp can be adjusted manually, and the front and rear contact surface is equipped with rubber anti-skid rubber pad. In this invention, the structure of the pet ramp is a pure mechanical folding adjustable Angle device, which is easy to use, stable and has a small volume.

The pet ramp of the present invention can adjust the front end angle hinge of the ramp on the pet steps, the car trunk and other terrain, so that it can be smoothly placed in the use environment. Rubber pads at the front and rear ends can avoid the ladder relative sliding and protect the use environment. And the pet ladder itself uses aluminum alloy material, the material of the ladder surface is wood plate, the weight is relatively light and the plate surface is covered with a layer of anti-skid sand, providing sufficient grip for the pet up and down the ramp. After folding, small volume, easy to carry.

Compared with the related techniques, a folding adjustable ramp angle pet ladder provided by the present invention has the following beneficial effects:

The present invention provides a pet ladder with a foldable adjustable ramp angle, operating between the first ladder body 1 and the second ladder body 2 and the fixed plate 3, the non-slip assembly 11 and the rotating assembly 7 with the adjusting frame 10, according to the ramp conversion angle, the pet ramp with excellent comfort and environmental protection.

### Second Embodiment

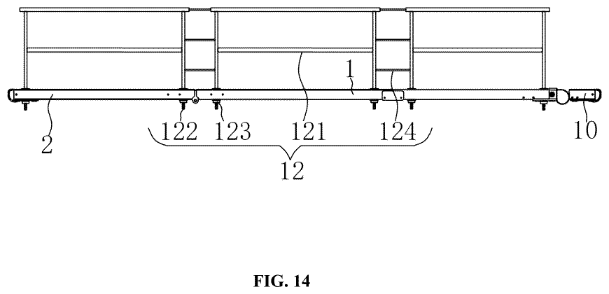

Referring also to FIG. 14, the second embodiment of the present application proposes a pet ladder as provided in the first embodiment of the present application. The second embodiment is only a preferred mode of the first embodiment, and the implementation of the second embodiment will not affect the separate implementation of the first embodiment.

Specifically, a pet ladder adjusting the ramp angle provided by the second embodiment of the present application differs in that a pet ladder of the first ladder body 1 and the surface of the second ladder body 2 are provided with a protective assembly 12 including a plurality of barriers 121, the bottom end of the barrier 121 connected with the outer threaded connection block 122, and the surface thread of the outer thread connection block 122 with a threaded sleeve 123.

On the surface of the first ladder body 1 and the second ladder body 2 are a plurality of threaded holes for the second ladder body 2, and the outer thread connection block 122 and the thread sleeve 123 facilitate the installation between the guard barrier 121 and the first ladder body 1 or the second ladder body 2.

A connecting rope 124 is provided between the plurality of said guard rails 121.

The invention provides a pet ladder of adjustable ramp angle works as follows:

When the pet is trained on the first ladder body 1 and the second ladder body 2, the guard rail 121 with the outer thread connection block 122 and the first ladder body 1 or the second ladder body 2. After the guard barrier 121 is placed, the outer thread connection block 123 runs through the first ladder body 1 or the second ladder body 2, and the outer thread connection block 122 through the thread sleeve 123.

Compared with the related techniques, a folding adjustable ramp angle pet ladder provided by the present invention has the following beneficial effects:

The present invention provides a pet ladder, with the installation between the first ladder body 1 and the two second ladder body 2, the guard barrier 121, the outer thread connection block 1222, and the first ladder body 1 and the second ladder body 2, preventing the damage during the pet training.

### The Third Embodiment

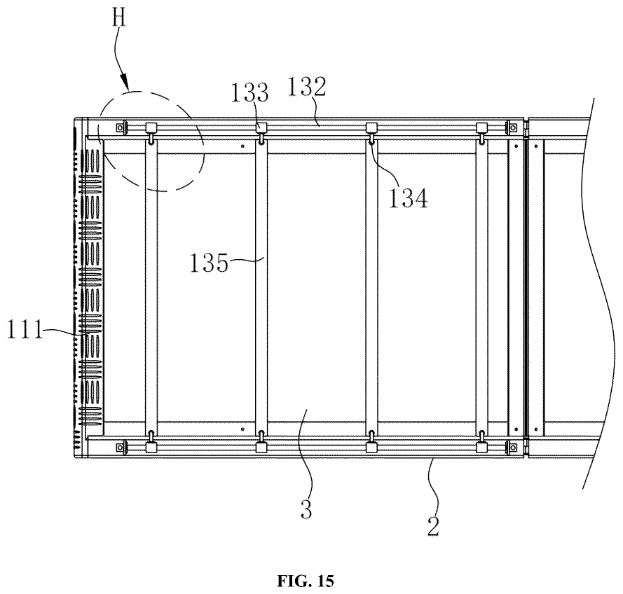

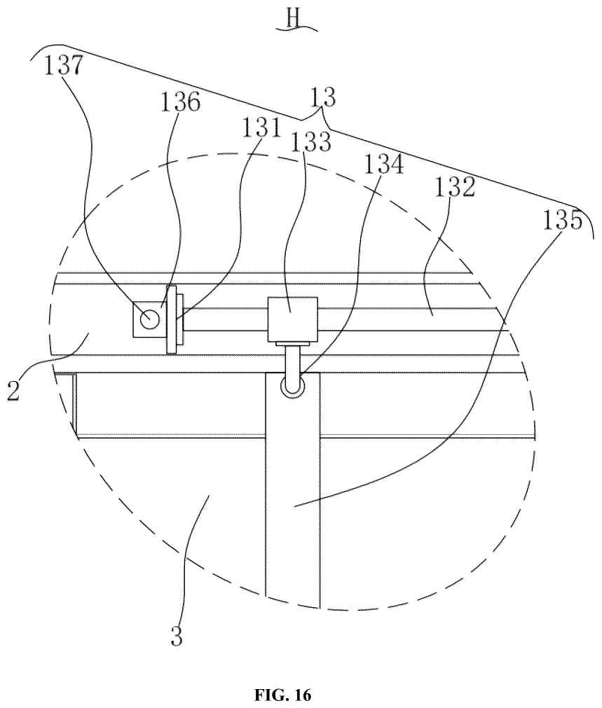

With reference to FIG. 15 and FIG. 16, based on the pet ladder of the first embodiment of the application, the third embodiment of the application. The third embodiment is only a preferred mode of the first embodiment, and the implementation of the third embodiment will not affect the separate implementation of the first embodiment.

concrete, The difference of a pet ladder adjusting the ramp angle provided by the third embodiment of the present application is in that, A pet ladder that folds up to adjust the ramp angle, The finite bit assembly 13 is provided between the first ladder body 1 and the fixing plate 3, The limit assembly 13 includes four positioning seats 131, Four described positioning seats 131 two into one group, The circular rod 131 is connected between the two positioning seats 131, The surface sleeve of the circular rod 132 is provided with a fixing sleeve 133, The side of the fixing sleeve 133 is connected to a L-shaped connecting rod 134, One end of the L-shaped connecting rod 134 is connected to a finbit plate 135.

The use of the circular rod 132 and the L-shaped connecting rod 134 facilitates the installation of the limit plate 135.

One side of the positioning seat 131 is connected with a rectangular block 136, having bolts 137 provided between the rectangular block 136 and the first ladder body 1.

The invention provides a pet ladder of adjustable ramp angle works as follows:

In use, when the position of the pet foot is increased, the circular rod 132 with the limited bit plate 135 is first placed on the surface of the first ladder body 1 or the second ladder body 2, and then passes through the rectangular block 136 of the positioning seat 131 through the bolt 137 and is threaded connected with the first ladder body 1 or the second ladder body 2.

Compared with the related techniques, a folding adjustable ramp angle pet ladder provided by the present invention has the following beneficial effects:

The present invention provides a pet ladder, in which the position of the pet limit components 13 is provided on the surface of the first ladder body 1 with the fixing plate 3 and the second ladder body 2 with the fixing plate 3.

The above is only the embodiments of the invention and do not thus limit the patent scope of the invention. All the equivalent structure or equivalent process transformations made by the invention description and the contents of the attached drawings, or directly or indirectly applied in other relevant technical fields, are similarly included in the scope of patent protection of the invention.

What is claimed is:

1. A pet ladder that adjusts the angle of the ramp, its characteristics are, includes:
The first ladder body and two second ladder bodies, the first ladder body and the two second ladder bodies are provided with fixed plates;
Turning members, the number of turning members is two, two connected to the opposite side of the first ladder body and one of the second ladder body;
A rotary assembly, disposed on the side of the second ladder body opposite to the first ladder body;
Anti-skid assembly, the protective assembly is provided at one end of the second ladder body;
Rorotary assembly, the rotary assembly is disposed at one end of one of the second ladder body;
Regulating frame, the regulating erection is placed on the side of the rotating assembly.

2. A pet ladder that adjusts the angle of the ramp according to claim 1, wherein the rotating assembly comprises two rotating blocks provided between having a rotating bar.

3. A pet ladder that adjusts the angle of the ramp according to claim 1, wherein the rotating assembly comprises a mounting block, both left and right of the mounting frame, a finite block between the two gear blocks, and a spring on one side of the limit block.

4. A pet ladder that adjusts the angle of the ramp according to claim 3, wherein the mounting frame and two gear blocks are provided with a protective fitting at one end of the second ladder body.

5. A pet ladder that adjusts the angle of the ramp according to claim 1, wherein the protective assembly comprises a skid block connected to a side and a side of the rotating block is connected to the second ladder body.

6. A pet ladder that adjusts the angle of the ramp according to claim 1, wherein a support plate is provided between the first ladder body and the second ladder body and the fixing plate.

7. A pet ladder that adjusts the angle of the ramp according to claim 1, with the left and right sides of the first ladder body and the surface of the second ladder body, the protective assembly includes a plurality of barriers, the bottom end of the barrier is connected with an outer thread connection block, and the surface thread of the outer threaded connection block is connected with a thread sleeve.

8. A pet ladder that adjusts the angle of the ramp according to claim 7, wherein a connecting rope is provided between the plurality of the guard rails.

9. A pet ladder that adjusts the angle of the ramp according to claim 1, wherein the finite assembly is provided between the first ladder body and the fixing plate, the limit assembly comprises four positioning seats, four of two with a circular rod, the surface sleeve of the circular rod has a fixing sleeve, one side of the fixing sleeve is connected with an L-shaped connecting rod, and one end of the L-shaped connecting rod is connected with a finite plate.

10. A pet ladder that adjusts the angle of the ramp according to claim 9, wherein one side of the positioning seat is connected to a rectangular block having a bolt between the rectangular block and the first ladder body.
